(19) United States
(12) Patent Application Publication
(10) Pub. No.: US 2024/0069425 A1
(43) Pub. Date: Feb. 29, 2024

(54) ILLUMINATION SYSTEM AND PROJECTION APPARATUS

(71) Applicant: Coretronic Corporation, Hsin-Chu (TW)

(72) Inventors: Chun-Hsin Lu, Hsin-Chu (TW); Jen-Wei Kuo, Hsin-Chu (TW); Wen-Chieh Chung, Hsin-Chu (TW)

(73) Assignee: Coretronic Corporation, Hsin-Chu (TW)

(21) Appl. No.: 18/454,816

(22) Filed: Aug. 24, 2023

(30) Foreign Application Priority Data
Aug. 29, 2022 (CN) 202222274605.2

(51) Int. Cl. G03B 21/28; G03B 21/20

(52) U.S. Cl. CPC G03B 21/28; G03B 21/2013

(57) ABSTRACT

An illumination system including two light source modules, two light guiding modules, a first reflector, and a light homogenization element is provided. The two light guiding modules are respectively disposed on transmission paths of light beams generated by the two light source modules to generate two guiding light beams. One of the guiding light beams is reflected to the light homogenization element by the first reflector. The other of the guiding light beams is directly transmitted to the light homogenization element. The guiding light beams are emitted from the light homogenization element and form an illumination light beam. A projection apparatus is also provided.

### CROSS-REFERENCE TO RELATED APPLICATION

This application claims the priority benefit of Chinese application no. 202222274605.2, filed on Aug. 29, 2022. The entirety of the above-mentioned patent application is hereby incorporated by reference herein and made a part of this specification.

### BACKGROUND

### Technical Field

The disclosure relates to an optical system and an optical device. In particular, the disclosure relates to an illumination system and a projection apparatus applying the illumination system.

### Description of Related Art

Currently, in a projection apparatus with a solid-state light source, a light combining structure may be configured to combine light emitted by two light source modules so as to improve brightness of the projection apparatus. In the light combining structure, a reflector and a color separating mirror are mainly configured to combine a plurality of color lights such as red light, green light, and blue light into white light. After that, light paths of two sets of white lights are combined and the white light is incident to a lens element array to form an illumination light beam. Lastly, the illumination light beam is converted into an image light beam by a light valve, and the image light beam is projected out of the projection apparatus by a projection lens.

However, when a small aperture lens is used for the projection lens, light-collecting efficiency of the illumination system of the projection apparatus is adversely affected, adversely affecting image quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system and a projection apparatus using the illumination system, in which light-collecting efficiency for the illumination light beam and uniformity of the illumination light beam can be improved. In addition, image quality may be improved when using small aperture lenses.

Other objectives and advantages of the disclosure can be further understood from the technical features disclosed in the disclosure.

To achieve one, some, or all of the above objectives or other objectives, an embodiment of the disclosure provides an illumination system including two light source modules, two light guiding modules, a first reflector, and a light homogenization element. Each of the two light source modules includes a plurality of light sources and is configured to provide a plurality of light beams. The two light guiding modules are respectively disposed on transmission paths of the light beams generated by the two light source modules to respectively generate two guiding light beams. The first reflector is disposed on a transmission path of one of the two guiding light beams. The one of the two guiding light beams is reflected to the light homogenization element by the first reflector. The other of the two guiding light beams is directly transmitted to the light homogenization element. The light homogenization element receives the two guiding light beams. The two guiding light beams are emitted from the light homogenization element and form an illumination light beam.

In an embodiment of the disclosure, the two guiding light beams are respectively emitted from the two light guiding modules in transmission directions perpendicular to each other.

In an embodiment of the disclosure, each of the light guiding modules includes a color separating mirror and a second reflector. At least one of the light beams emitted by each of the light source modules is passed through the color separating mirror and transmitted to the light homogenization element. The other of the light beams emitted by each of the light source modules are sequentially reflected by the second reflector, reflected by the color separating mirror, and transmitted to the light homogenization element.

In an embodiment of the disclosure, the first reflector is non-perpendicular and non-parallel to any one of the color separating mirrors.

In an embodiment of the disclosure, the first reflector is non-perpendicular and non-parallel to any one of the second reflectors.

In an embodiment of the disclosure, the one of the two guiding light beams is incident to the first reflector at an incident angle and emitted from the first reflector at an emitted angle. A sum of the incident angle and the emitted angle is less than 90 degrees.

In an embodiment of the disclosure, the two guiding light beams are incident to the light homogenization element at respective incident angles. The incident angles are not equal to each other.

In an embodiment of the disclosure, the other of the two guiding light beams is vertically incident to the light homogenization element.

In an embodiment of the disclosure, light spots of the two guiding light beams incident to the light homogenization element are overlapped.

In an embodiment of the disclosure, main optical axes of the two light source modules are perpendicular to each other.

In an embodiment of the disclosure, the two guiding light beams are incident to the light homogenization element in directions non-perpendicular and non-parallel to each other.

To achieve one, some, or all of the above objectives or other objectives, an embodiment of the disclosure further provides a projection apparatus including an illumination system, a light valve, and a projection lens. The illumination system is configured to generate an illumination light beam and includes two light source modules, two light guiding modules, a first reflector, and a light homogenization element. Each of the two light source modules includes a plurality of light sources and is configured to provide a plurality of light beams. The two light guiding modules are respectively disposed on transmission paths of the light beams generated by the two light source modules to respectively generate two guiding light beams. The first reflector is disposed on a transmission path of one of the two guiding light beams. The one of the two guiding light beams is reflected to the light homogenization element by the first reflector. The other of the two guiding light beams is directly transmitted to the light homogenization element. The light homogenization element receives the two guiding light beams. The two guiding light beams are emitted from the light homogenization element and form the illumination light beam. The light valve is disposed on a transmission path of the illumination light beam and configured to convert the illumination light beam into an image light beam. The projection lens is disposed on a transmission path of the image light beam and configured to project the image light beam out of the projection apparatus.

In an embodiment of the disclosure, the two guiding light beams are respectively emitted from the two light guiding modules in transmission directions substantially perpendicular to each other.

In an embodiment of the disclosure, each of the light guiding modules includes a color separating mirror and a second reflector. At least one of the light beams emitted by each of the light source modules is passed through the color separating mirror and transmitted to the light homogenization element. The other of the light beams emitted by each of the light source modules are sequentially reflected by the second reflector, reflected by the color separating mirror, and transmitted to the light homogenization element.

In an embodiment of the disclosure, the first reflector is non-perpendicular and non-parallel to any one of the color separating mirrors.

In an embodiment of the disclosure, the first reflector is non-perpendicular and non-parallel to any one of the second reflectors.

In an embodiment of the disclosure, the one of the two guiding light beams is incident to the first reflector at an incident angle and emitted from the first reflector at an emitted angle. A sum of the incident angle and the emitted angle is less than 90 degrees.

In an embodiment of the disclosure, the two guiding light beams are incident to the light homogenization element at respective incident angles. The incident angles are not equal to each other.

In an embodiment of the disclosure, the other of the two guiding light beams is vertically incident to the light homogenization element.

In an embodiment of the disclosure, light spots of the two guiding light beams incident to the light homogenization element are overlapped.

Based on the foregoing, in an embodiment of the disclosure, in the illumination system and the projection apparatus using the illumination system, two light source modules are configured to generate illumination light beams, and the first reflector is configured to make the two guiding light beams incident to the light homogenization element in directions that are non-perpendicular and non-parallel to each other. Accordingly, the reduced size of the light spot of the illumination light beams emitted from the light homogenization element helps improve the light-collecting efficiency of the illumination system to cooperate with the projection apparatus using a projection lens with a small aperture, improving the image quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection apparatus according to an embodiment of the disclosure.

FIG. 2A is a schematic view of an illumination system in a projection apparatus according to an embodiment of the disclosure.

FIG. 2B is a schematic view of a light source module in FIG. 2A.

FIG. 2C is a schematic enlarged view of a guiding light beam reflected by the first reflector in FIG. 2A.

FIG. 2D is a schematic enlarged view of two guiding light beams incident to the light homogenization element in FIG. 2A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

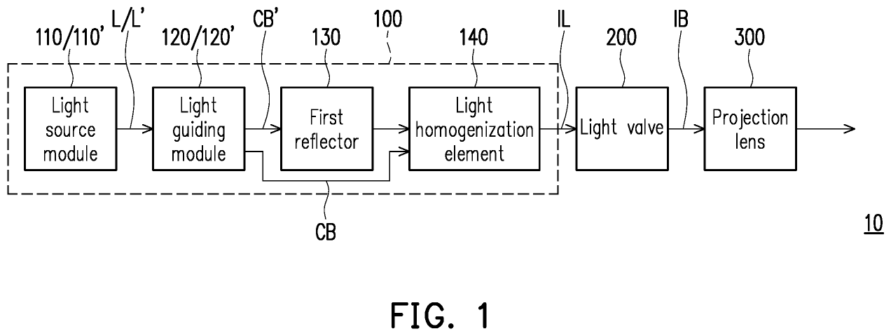

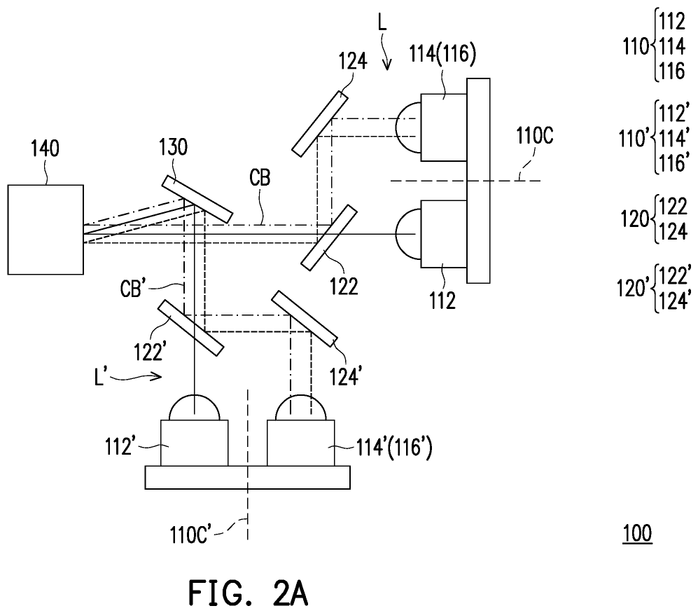

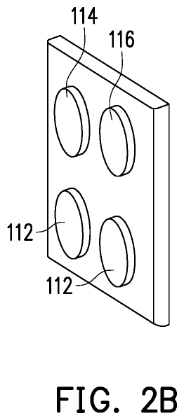

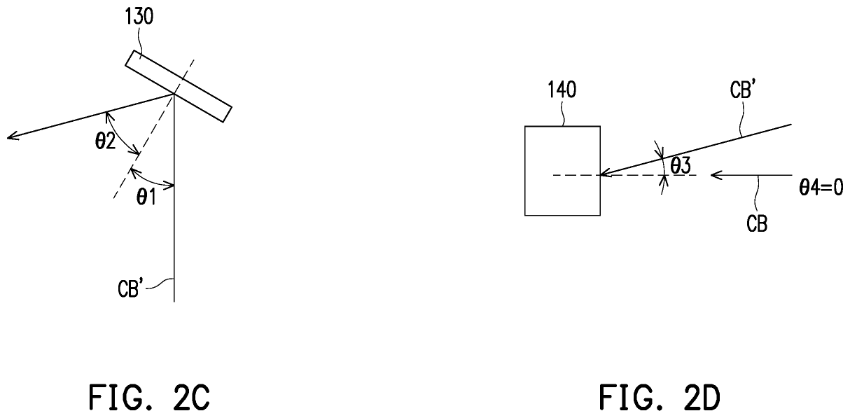

FIG. 1 is a schematic view of a projection apparatus according to an embodiment of the disclosure. FIG. 2A is a schematic view of an illumination system in a projection apparatus according to an embodiment of the disclosure. FIG. 2B is a schematic view of a light source module in FIG. 2A. With reference to FIG. 1, FIG. 2A, and FIG. 2B, an embodiment of the disclosure provides a projection apparatus 10 including an illumination system 100, a light valve 200, and a projection lens 300.

In this embodiment, the light valve 200 is a spatial light modulator, for example, a digital micro-mirror device (DMD), a liquid-crystal-on-silicon panel (LCOS Panel), a liquid crystal panel, or the like. In addition, the projection lens 300 includes, for example, an optical lens element or a combination of optical lens elements having a refractive power. The optical lens element includes various combinations of non-planar lens elements, for example, a biconcave lens element, a biconvex lens element, a concavo-convex lens element, a convexo-concave lens element, a plano-convex lens element, and a plano-concave lens element. The disclosure does not limit the form and the type of the projection lens 300.

In this embodiment, the illumination system 100 is configured to generate an illumination light beam IL. The light valve 200 is disposed on a transmission path of the illumination light beam IL, and is configured to convert the illumination light beam IL into an image light beam IB. The projection lens 300 is disposed on a transmission path of the image light beam IB, and is configured to project the image light beam IB out of the projection apparatus 10.

In this embodiment, the illumination system 100 may include two light source modules 110 and 110′, two light guiding modules 120 and 120′, a first reflector 130, and a light homogenization element 140. Each of the light source modules 110 and 110′ may include a plurality of light sources 112, 112′, 114, 114′, 116, and 116′ and is configured to provide a plurality of light beams L and L′. The light sources 112, 112′, 114, 114′, 116, and 116′ may be light-emitting diodes (LEDs) or laser diodes (LDs). The light beams L and L′ may be at least one of red, green, and blue light beams. For example, the light sources 112 and 112′ may provide red light beams, the light sources 114 and 114′ may provide green light beams, and the light sources 116 and 116′ may provide blue light beams. Nonetheless, the disclosure is not limited thereto.

In this embodiment, with reference to FIG. 2A and FIG. 2B, the light source module 110/110′ includes two light sources 112/112′, one light source 114/114′ and one light source 116/116′. The light sources 112/112′ face a color separating mirror 122/122′. No other optical elements are disposed between the light sources 112/112′ and the color separating mirror 122/122′, so as to minimize the volume of the illumination system 100. The light source 114/114′ and the light source 116/116′ face a second reflector 124/124′. Similarly, no other optical elements are disposed between the light sources 114/114′ and 116/116′ and the second reflector 124/124′, so as to minimize the volume of the illumination system 100. The color separating mirror 122/122′ is, for example, a dichroic mirror, and serves to pass the red light beam and reflect the green light beam and the blue light beam.

In this embodiment, the two light guiding modules 120 and 120′ are respectively configured on transmission paths of the light beams L and L′ generated by the two light source modules 110 and 110′ to respectively generate two guiding light beams CB and CB′. The guiding light beams CB and CB′ include at least one of red, green, and blue light beams. Each of the light guiding module 120/120′ includes the color separating mirror 122/122′ and the second reflector 124/124′. At least one of the light beams L/L′ emitted by each of the light source modules 110 and 110′ (e.g., the light beams L/L′ emitted by the light sources 112/112′) is passed through the color separating mirror 122/122′ and transmitted to the light homogenization element 140. The other of the light beams L/L′ emitted by each of the light source modules 110 and 110′ (i.e., the light beams L/L′ emitted by the light sources 114/114′ and 116/116′) are sequentially reflected by the second reflector 124/124′ and transmitted to the color separating mirror 122/122′, and reflected by the color separating mirror 122/122′ and transmitted to the light homogenization element 140.

In this embodiment, the first reflector 130 is disposed on a transmission path of one of the two guiding light beams CB and CB′ (i.e., on a transmission path of the guiding light beam CB′). The one of the two guiding light beams CB and CB′ is reflected by the first reflector 130 to the light homogenization element 140. The other of the two guiding light beams CB and CB′ (i.e., the guiding light beam CB) is directly transmitted to the light homogenization element 140. The light homogenization element 140 receives the two guiding light beams CB and CB′. Main optical axes 110C and 110C′ of the two light source modules 110 and 110′ are substantially perpendicular to each other. The main optical axes 110C and 110C′ may be defined as normal lines of the light emitting surfaces of the light source module 110 and 110′ that are parallel to the directions in which the light beams L and L′ are emitted from the light source module 110 and 110′.

In this embodiment, the two guiding light beams CB and CB′ are emitted from the light homogenization element 140 and form the illumination light beam IL. The illumination light beam IL includes at least one of red, green, and blue light beams. The light homogenization element 140 is, for example, an integration rod, a lens element array, or other optical elements having a light homogenization effect, but the disclosure is not limited thereto.

In addition, in this embodiment, the two guiding light beams CB and CB′ are incident to the light homogenization element 140 in directions that are non-perpendicular and non-parallel to each other. The two guiding light beams CB and CB′ are respectively emitted from the two light guiding modules 120 and 120′ in transmission directions that are perpendicular to each other.

In this embodiment, the first reflector 130 is non-perpendicular and non-parallel to any one of the color separating mirrors 122 and 122′. The first reflector 130 is non-perpendicular and non-parallel to any one of the second reflectors 124 and 124′.

In this embodiment, the other of the two guiding light beams CB and CB′ is vertically incident to the light homogenization element 140. Furthermore, light spots of the two guiding light beams CB and CB′ incident to the light entrance end of the light homogenization element 140 are overlapped.

FIG. 2C is a schematic enlarged view of a guiding light beam reflected by the first reflector in FIG. 2A. With reference to FIG. 2A and FIG. 2C, in this embodiment, the one of the two guiding light beams CB and CB′ (e.g., the guiding light beam CB′) is incident to the first reflector 130 at an incident angle θ1 and emitted from the first reflector 130 at an emitted angle θ2. A sum of the incident angle θ1 and the emitted angle θ2 is less than 90 degrees.

FIG. 2D is a schematic enlarged view of two guiding light beams incident to the light homogenization element in FIG. 2A. With reference to FIG. 2A and FIG. 2D, in this embodiment, the two guiding light beams CB′ and CB are incident to the light homogenization element 140 at respective incident angles θ3 and 04 that are not equal. The guiding light beam CB′ is reflected from the first reflector 130 to the light homogenization element 140. The guiding light beam CB is vertically incident to the light homogenization element 140, so that the incident angle θ4=0.

In summary of the foregoing, in an embodiment of the disclosure, in the illumination system and the projection apparatus using the illumination system, since two light source modules are configured to generate illumination light beams, illumination light beams having relatively high brightness and relatively high uniformity may be provided. The illumination system is provided with the first reflector, so that the two guiding light beams are incident to the light homogenization element in directions that are non-perpendicular and non-parallel to each other. Accordingly, the two guiding light beams may be designed to be close to each other on the transmission paths of the light beams when being incident to the light homogenization element to reduce the size of the light spot of the illumination light beams emitted from the light homogenization element. The reduced size of the light spot of the illumination light beams emitted from the light homogenization element helps improve the light-collecting efficiency of the illumination system to cooperate with the projection apparatus using a projection lens with a small aperture, improving the image quality.

Furthermore, in an embodiment, the two guiding light beams may be designed to be relatively close on the light path when being incident to the light homogenization element, so that the light spots of the two guiding light beams incident to the light entrance end of the light homogenization element are overlapped, thus improving the light uniformity of the illumination system.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system comprising:
two light source modules each comprising a plurality of light sources and configured to provide a plurality of light beams;
two light guiding modules respectively disposed on transmission paths of the light beams generated by the two light source modules to respectively generate two guiding light beams;
a first reflector disposed on a transmission path of one of the two guiding light beams; and
a light homogenization element,
wherein the one of the two guiding light beams is reflected to the light homogenization element by the first reflector, the other of the two guiding light beams is directly transmitted to the light homogenization element, the light homogenization element receives the two guiding light beams, and the two guiding light beams are emitted from the light homogenization element and form an illumination light beam.

2. The illumination system according to claim 1, wherein the two guiding light beams are respectively emitted from the two light guiding modules in transmission directions substantially perpendicular to each other.

3. The illumination system according to claim 1, wherein each of the light guiding modules comprises a color separating mirror and a second reflector, at least one of the light beams emitted by each of the light source modules is passed through the color separating mirror and transmitted to the light homogenization element, and the other of the light beams emitted by each of the light source modules are sequentially reflected by the second reflector, reflected by the color separating mirror, and transmitted to the light homogenization element.

4. The illumination system according to claim 3, wherein the first reflector is non-perpendicular and non-parallel to any one of the color separating mirrors.

5. The illumination system according to claim 3, wherein the first reflector is non-perpendicular and non-parallel to any one of the second reflectors.

6. The illumination system according to claim 1, wherein the one of the two guiding light beams is incident to the first reflector at an incident angle and emitted from the first reflector at an emitted angle, and a sum of the incident angle and the emitted angle is less than 90 degrees.

7. The illumination system according to claim 1, wherein the two guiding light beams are incident to the light homogenization element at respective incident angles, and the incident angles are not equal to each other.

8. The illumination system according to claim 1, wherein the other of the two guiding light beams is vertically incident to the light homogenization element.

9. The illumination system according to claim 1, wherein light spots of the two guiding light beams incident to the light homogenization element are overlapped.

10. The illumination system according to claim 1, wherein main optical axes of the two light source modules are perpendicular to each other.

11. The illumination system according to claim 1, wherein the two guiding light beams are incident to the light homogenization element in directions non-perpendicular and non-parallel to each other.

12. A projection apparatus comprising:
an illumination system configured to generate an illumination light beam and comprising:
two light source modules each comprising a plurality of light sources and configured to provide a plurality of light beams;
two light guiding modules respectively disposed on transmission paths of the light beams generated by the two light source modules to respectively generate two guiding light beams;
a first reflector disposed on a transmission path of one of the two guiding light beams; and
a light homogenization element,
wherein the one of the two guiding light beams is reflected to the light homogenization element by the first reflector, the other of the two guiding light beams is directly transmitted to the light homogenization element, the light homogenization element receives the two guiding light beams, and the two guiding light beams are emitted from the light homogenization element and form the illumination light beam;
a light valve disposed on a transmission path of the illumination light beam and configured to convert the illumination light beam into an image light beam; and
a projection lens disposed on a transmission path of the image light beam and configured to project the image light beam out of the projection apparatus.

13. The projection apparatus according to claim 12, wherein the two guiding light beams are respectively emitted from the two light guiding modules in transmission directions substantially perpendicular to each other.

14. The projection apparatus according to claim 12, wherein each of the light guiding modules comprises a color separating mirror and a second reflector, at least one of the light beams emitted by each of the light source modules is passed through the color separating mirror and transmitted to the light homogenization element, and the other of the light beams emitted by each of the light source modules are sequentially reflected by the second reflector, reflected by the color separating mirror, and transmitted to the light homogenization element.

15. The projection apparatus according to claim 14, wherein the first reflector is non-perpendicular and non-parallel to any one of the color separating mirrors.

16. The projection apparatus according to claim 14, wherein the first reflector is non-perpendicular and non-parallel to any one of the second reflectors.

17. The projection apparatus according to claim 12, wherein the one of the two guiding light beams is incident to the first reflector at an incident angle and emitted from the first reflector at an emitted angle, and a sum of the incident angle and the emitted angle is less than 90 degrees.

18. The projection apparatus according to claim 12, wherein the two guiding light beams are incident to the light homogenization element at respective incident angles, and the incident angles are not equal to each other.

19. The projection apparatus according to claim 12, wherein the other of the two guiding light beams is vertically incident to the light homogenization element.

20. The projection apparatus according to claim 12, wherein light spots of the two guiding light beams incident to the light homogenization element are overlapped.
